(19) United States
(12) Patent Application Publication
(10) Pub. No.: US 2017/0308580 A1
(43) Pub. Date: Oct. 26, 2017

(54) Data Aggregation/Analysis System and Method Therefor

(71) Applicant: Hitachi, Ltd., Chiyoda-ku, Tokyo (JP)

(72) Inventors: Ken NAGANUMA, Tokyo (JP); Masayuki YOSHINO, Tokyo (JP); Yoshinori SATOU, Tokyo (JP); Hisayoshi SATO, Tokyo (JP)

(21) Appl. No.: 15/509,972

(22) PCT Filed: Jan. 26, 2015
(86) PCT No.: PCT/JP2015/052041

§ 371 Date: Mar. 9, 2017

(51) Int. Cl. G06F 17/30; H04L 9/30; H04L 9/14; H04L 9/08; H04L 9/06; H04L 29/06; H04L 9/00

(52) U.S. Cl. CPC G06F 17/30513; H04L 63/0428; H04L 9/30; H04L 9/008; H04L 9/0861; H04L 9/0618; H04L 9/14

(57) ABSTRACT

This data aggregation/analysis system includes a user terminal and a database server. The user terminal comprises, a private key generation unit, an encrypted tabulated data generation unit which encrypts cells of tabulated data, an encrypted analysis query generation unit which generates an encrypted analysis query by encrypting item names of an analysis subject using a private key, and a transmission unit which transmits encrypted tabulated data, etc. The database server comprises: a storage unit which stores encrypted tabulated data, etc.; a tokenization unit which, upon reception of an encrypted analysis query, performs a search process using a searchable code matching function and receiving the encrypted analysis query and encrypted tabulated data as input, and tokenizes each found cell of encrypted tabulated data into a character string, thereby generating partially-tokenized encrypted tabulated data; a data analysis processing unit which receives the partially-tokenized encrypted tabulated data as input and generates a data analysis result; and a transmission unit which transmits the data analysis result to the user terminal.

### TECHNICAL FIELD

The present invention relates to a data aggregation/analysis system that performs analysis such as aggregation on tabular data in which each cell is encrypted without decrypting the encrypted data, and to a method for the data aggregation/analysis system.

### BACKGROUND ART

Big-data businesses that collect and analyze large amounts of data and extract valuable knowledge have become popular in recent years. Analyzing large amounts of data requires large capacity storage and high speed CPU, as well as a system for controlling these components in a distributed manner. For this reason, companies sometimes outsource the analysis to external resources such as clouds. However, a problem with privacy arises when outsourcing data to others. Thus, security analytics techniques have been developed to perform analysis by outsourcing data after being subjected to encryption and other privacy protection measures, which have received attention.

To solve this problem with privacy that occurs during data analysis, Nonpatent Literature 1 describes a method for performing aggregate analysis and association rule analysis on data while being encrypted by using common key searchable encryption. Further, Patent Literature 1 describes a searchable encryption scheme.

### CITATION LIST

### Patent Literature

Patent Literature 1: Japanese Patent Application Publication No. 2012-123614

### Nonpatent Literature

Nonpatent Literature 1: Naganuma et al. “Kensaku kano ango wo mochiita hitoku bunseki shuho”, SCIS 2014 The 31^{st} Symposium on Cryptography and Information Security, Kagoshima Japan, Jun. 21-24, 2014, The Institute of Electronics, Information and Communication Engineers

### SUMMARY OF INVENTION

### Technical Problem

The common key searchable encryption described in Nonpatent Literature 1 is a generic term for an encryption system that can perform match determination (matching process) on encrypted data (without being decoded), in addition to a common key encryption function to perform normal probabilistic encryption and decryption. The generation of encrypted search queries used in encryption, decryption, and search can be done only by a decryption right holder who has a private key. On the other hand, the matching process between encrypted text and encrypted query can be done by an analysis process performer who does not have a private key or by an analysis server.

Nonpatent Literature 1 describes a method for counting the number of appearances of a specific encrypted text in an encrypted state by using a matching process function of common key searchable encryption, to perform aggregate analysis and association rule analysis using the appearance frequency information. Because the method counts the number of appearances of encrypted text by using searchable encryption, process efficiency is a problem.

### Solution to Problem

The disclosed data aggregation/analysis system includes a user terminal including: a private key generation unit that generates a private key; an encrypted tabular data generation unit that encrypts cells of tabular data to generate encrypted tabular data; an encrypted analysis query generation unit that generates an encrypted analysis query by an item name, which is the analysis target of the tabular data, by using the private key; and a transmission unit that transmits the encrypted tabular data, the searchable encryption matching function of the searchable encryption algorithm, and the encrypted analysis query. The disclosed data aggregation/analysis system also includes a database server including: a storage unit that stores the encrypted tabular data and the searchable encryption matching function; a tokenization unit that performs a retrieval process, in response to receiving the encrypted analysis query, by using the searchable encryption matching function with the encrypted analysis query and the encrypted tabular data as input, and tokenizes cells hit in the retrieval process on the encrypted tabular data into arbitrary character strings to generate partially-tokenized encrypted tabular data; a data analysis processing unit that performs a predetermined data analysis process with the partially tokenized encrypted tabular data as input, to generate a data analysis result; and a transmission unit that transmits the data analysis result to the user terminal.

### Advantageous Effects of Invention

According to the disclosed data aggregation/analysis system, it is possible to improve the analysis process efficiency while protecting the privacy of the informant through encryption.

### BRIEF DESCRIPTION OF DRAWINGS

FIG. 1 is a schematic diagram of a data aggregation/analysis system according to a first example.

FIG. 2 is a schematic hardware diagram of a user terminal according to a first embodiment.

FIG. 3 is an example of the data format of plain text data.

FIG. 4 is an example of the data format of encrypted data.

FIG. 5 is a flow chart illustrating a pre-preservation process of the encrypted data of the first example.

FIG. 6 is an example of the data format of analysis query.

FIG. 7 is an example of the data format of encrypted analysis query.

FIG. 8 is an example of the data format of an analysis process result in the first example.

FIG. 9 is a flow chart illustrating an encryption and aggregate analysis process in the first example.

FIG. 10 is a flow chart illustrating a tokenization process.

FIG. 11 is an example of tokenization of the encrypted data.

FIG. 12 is a flow chart illustrating the aggregate analysis in the first example.

FIG. 13 is an example of the data format of plain data with dummy records.

FIG. 14 is an example of the data format of encrypted data with dummy records.

FIG. 15 is a flow chart illustrating a pre-preservation process of encrypted data in a second example.

FIG. 16 is a process flow chart illustrating an encryption and aggregate analysis process in the second example according to a second embodiment.

FIG. 17 is a flow chart illustrating an aggregate analysis process in the second example according to the second embodiment.

FIG. 18 is a diagram illustrating the aggregate analysis process in the second example.

FIG. 19 is an example of the data format of an analysis process result in the second example.

### DESCRIPTION OF EMBODIMENTS

Before a description of specific examples, a description of the concept of the present embodiment follows with reference to an example.

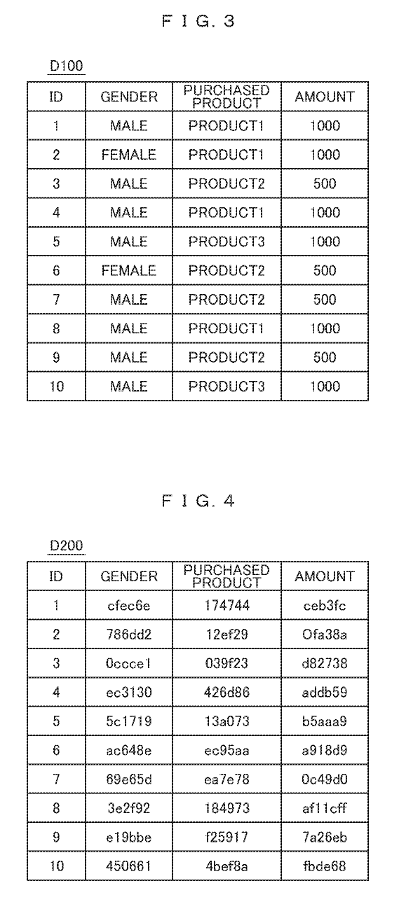

FIG. 3 shows plain text, and FIG. 4 shows encrypted data obtained by encrypting the plain text of FIG. 3 by means of searchable encryption. It is assumed that a server having the encrypted data counts the number of records with “male” for the gender column, the number of records with “product 1” for the purchased product column, and the number of records both with “male” for the gender column and with “product 1” for the purchased product column, by using an encrypted query of “male”, Query (male), and by using an encrypted query of “product 1”, Query (product 1).

The server performs a process of matching between the encrypted texts (10 texts in total) in each of the cells of the gender column and Query (male) by using a matching function of searchable encryption. Then, the server records the number of matching data, in this case 8, as the number of appearances of Query (male). Next, the server performs a process of matching between the encrypted texts (10 texts in total) in each of the cells of the purchased product column and Query (product 1) by using the matching function of searchable encryption. Then, the server records the number of matching data, in this case 4, as the number of appearances of Query (product 1). Finally, in order to count the records both with “male” for the gender column and with “product 1” for the purchased product column, the server performs a process of matching between the encrypted texts (10 texts in total) in each of the cells of the gender column and Query (male) by using the matching function of searchable encryption. Further, with respect to matching 8 records, the server performs a process of matching between the encrypted texts (8 texts) in each of the cells of the purchased product column and Query (product 1) by using the matching function of searchable encryption. Then, the server records the number of hit data, in this case 3, and then the process ends.

In the process described above, the server performs the matching process of searchable encryption 10+10+10+8=38 times. In general, the matching process of searchable encryption has poor process efficiency compared to the matching process on normal plain text, namely, binary match determination. For example, in the matching process of the searchable encryption process system described in Nonpatent Literature 1, an encryption function such as a hash function is called during the process, so that the matching process is a bottleneck in the whole analysis process in data analysis such as aggregate analysis. In particular, in the association rule analysis in which the matching process is performed multiple times on the same data, the matching process of searchable encryption is performed multiple times. As a result, the process efficiency is significantly reduced.

As described above, when performing analysis associated with the matching process multiple times on the same data with respect to the data encrypted by the searchable encryption, the server performs the matching process of searchable encryption multiple times. As a result, the process efficiency is significantly reduced. On the other hand, there is a method for performing tokenization (or also referred to as labeling). Tokenization is a method that typically converts specific data into character strings or numerical sequences with no particular meaning.

FIG. 11 is an example of tokenizing the encrypted data of FIG. 4. In data aggregation analysis, as shown in FIG. 11, when performing the matching process (or the call of matching process 10 times) on each cell of the gender column by means of Query (male) with respect to the encrypted data of FIG. 4, by using the matching process function of searchable encryption, the database server tokenizes (labels) the matching cell with a character “A”=Query (male). Further, when performing the matching process (or the call of matching process 10 times) on each cell of the purchased product column by means of Query (product 1) by using the matching process function of searchable encryption, the database server tokenizes (labels) the matching cell with a character “B”=Query (product 1). In this way, it is possible to increase the process efficiency by performing the matching process with normal binary matching using the character “A” for the search of Query (male), without calling the searchable encryption matching function in the subsequent analysis process. Actually, in the example of the aggregate analysis described above, by tokenizing Query (mail) with the character “A” and by tokenizing Query (product 1) with the character “B”, the database server does not perform the matching process of searchable encryption after performing the matching process of searchable encryption 10+10=20 times in total. As a result, 18 executions of the matching process of searchable encryption can be reduced.

### First Example

This example focuses on purchase history data configured with the gender column and the purchased product column which are described above, as well as an amount column as data to be aggregated and analyzed. However, the present invention is not limited to the purchase history data and may also be applied to more general tabular data.

FIG. 1 is a schematic diagram of a data aggregation/analysis system. As shown in the figure, the system is configured such that a user terminal 100 and a database server 200 are connected by a network 300 to mutually transmit and receive information.

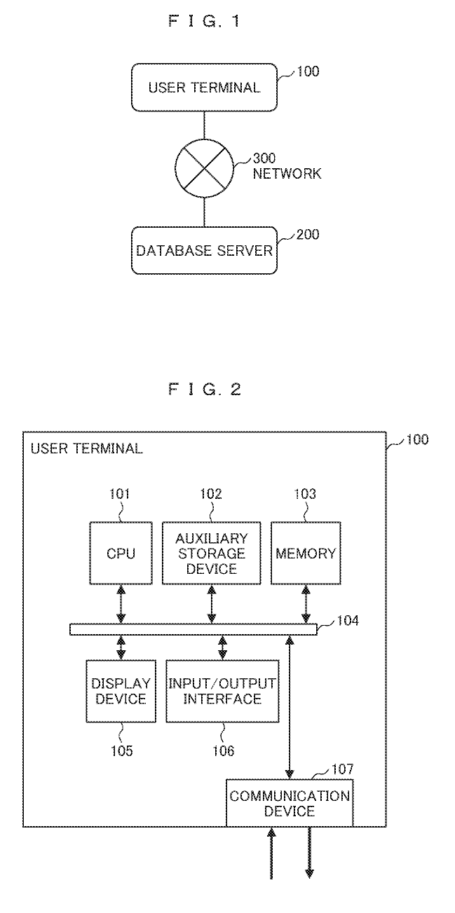

FIG. 2 is a schematic hardware diagram of the user terminal 100. As shown in the figure, the user terminal 100 is configured such that a CPU 101, an auxiliary storage device 102, a memory 103, a display device 105, an input/output interface 106, and a communication device 107 are connected by an internal signal line 104. The auxiliary storage device 102 stores a program code. The program code is loaded into the memory 103 and is executed by the CPU 101. The database server 200 has the same hardware configuration as the user terminal 100. In this way, both the user terminal 100 and the database server 200 are so-called computers.

The terms of the searchable encryption scheme used in the following description are defined.

Common key searchable encryption algorithm (hereinafter, referred to as searchable encryption) is a generic term for any encryption scheme that can perform match determination (hereinafter, matching process) on plain text with data kept encrypted and without being decoded, in addition to the common key encryption function that performs normal probabilistic encryption and decryption. An entity with a private key (for example, the user terminal 100 in this example) is allowed to generate encrypted search queries used in encryption, decryption, and search, but an entity with no private key (for example, the database server 200) is not allowed. On the other hand, an entity with no private key (for example, the database server 200 in this example) can perform the matching process between encrypted text and encrypted query. More specifically, the searchable encryption algorithm is configured to include a set of four functions of [searchable encrypted private key generation function, searchable cipher encryption function, searchable encrypted query function, searchable encryption matching function].

(1) Searchable Encrypted Private Key Generation Function

This term represents the private kay generation algorithm specified by the searchable encryption algorithm. Hereinafter, it is simply referred to as private key generation process. Given a security parameter and a key seed as function input, a binary string of specific bit length corresponding to the private key using functions as input in (2) and (3) is output.

(2) Searchable Cipher Encryption Function

This term represents the encryption algorithm specified by the searchable encryption algorithm. Given a plain text and a private key as function input, an encrypted text is output.

(3) Searchable Encrypted Query Function

This term represents the query generation algorithm specified by the searchable encryption algorithm. Given the plain text query and the private key as function input, an encrypted query is output.

(4) Searchable Encryption Matching Function

This term represents the matching algorithm between the encrypted text and the encrypted query that are specified by the searchable encryption algorithm. Given a ciphertext argument and an encrypted query argument as function input, [plain text match] is output as a result of when the plain text for the encrypted text matches the plain text pertaining to the encrypted query. Otherwise, [plain text mismatch] is output as the result.

This example describes the searchable encryption algorithm, namely, the searchable encryption private kay generation function, the searchable cipher encryption function, the searchable encrypted query function, and the searchable encryption matching function. Note that as a specific searchable encryption scheme, an existing method such as that shown in Patent Literature 1 may be used.

FIG. 3 is an example of the data format of plain text data (D100) held by the user terminal 100. As shown in the figure, the plain text data is a tabular data with the columns of ID, gender, purchased product, and amount.

FIG. 4 is an example of the data format of an encrypted data (D200) obtained by encrypting the plain text data (D100) of FIG. 3. As shown in the figure, each cell in the respective columns of gender, purchased column, and amount of the plain text (D100) is encrypted with the searchable cipher encryption function.

FIG. 5 is a flow chart illustrating an encrypted data pre-preservation process of the user terminal 100 and the database server 200. The user terminal 100 generates a private key used as input of the searchable cipher encryption function and the searchable encrypted query function, by using the searchable encrypted private key generation function (S100). The user terminal 100 generates the encrypted data (D200) by encrypting the plain text data held by the user terminal 100, by using the searchable cipher encryption function according to the data format shown in FIG. 4 (S200). The user terminal 100 transmits the encrypted data (D200) to the database server 200. The database server 200 stores the received encrypted data (D200), and then the pre-preservation process ends.

Note that the order of the item names (ID, gender, purchased product, and amount) described in each cell of the tabular table may be different depending on the record (row). In such a case, the user terminal 100 gives a specific total-order structure to the order of the item names, and sorts the item names described in each cell in the respective rows of the tabular data in which the order of the item names is different depending on the row, to rearrange the order of the item names of each row, for example, as shown in FIG. 3.

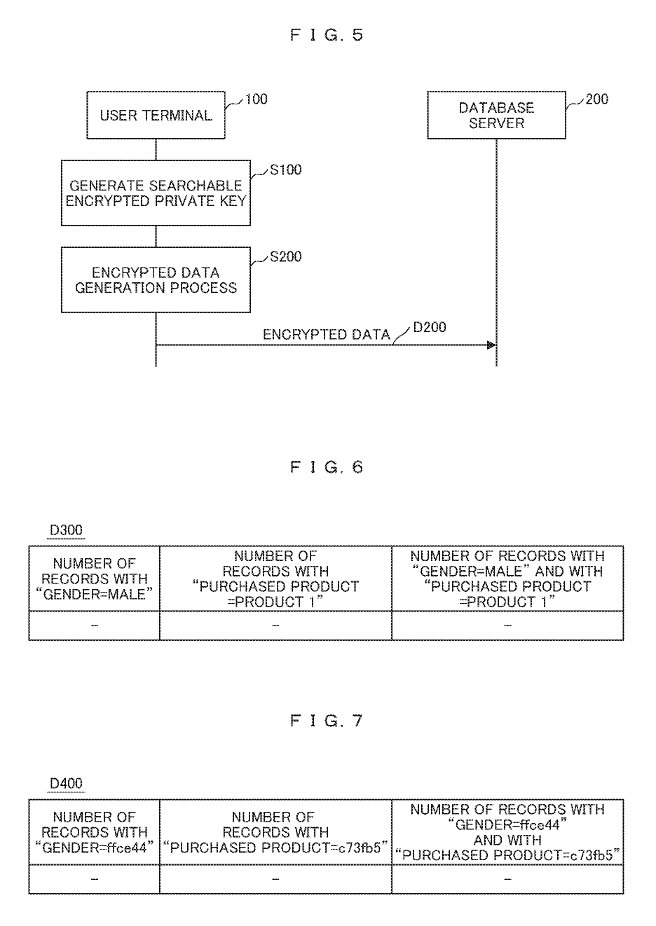

FIG. 6 is an example of the data format of an analysis query (D300) when the user terminal 100 requests the database server 200 to perform an aggregate analysis. In this example, the user terminal 100 requests aggregation of three values within the encrypted data (D200) stored in the database server 200 by the pre-preservation process described above. In other words, the user terminal 100 requests aggregation of the number of records with a value “male” in the gender column, the number of records with “product 1” in the purchased product column, and the number of records both with the value “male” in the gender column and with “product 1” in the purchased product column. At this time, as shown in FIG. 6, the analysis query (D300) generates a column for each of the three values on which the aggregation analysis is requested, with blank data in the field (record number column) to input the value (the number of records).

FIG. 7 is an example of the data format of an encrypted analysis query (D400) obtained by encrypting the analysis query (D300). As shown in the figure, “male” of the first column, which is the plain text part of the analysis query (D300), is encrypted into “ffce44” by the searchable encrypted query function. Similarly, “product 1” of the second column is encrypted into “c73fb5” by the searchable encrypted query function. Further, “male” and “product 1” of the third column are encrypted by the searchable encrypted query function. In this way, here, the encrypted analysis query (D400) includes a plurality of encrypted analysis queries.

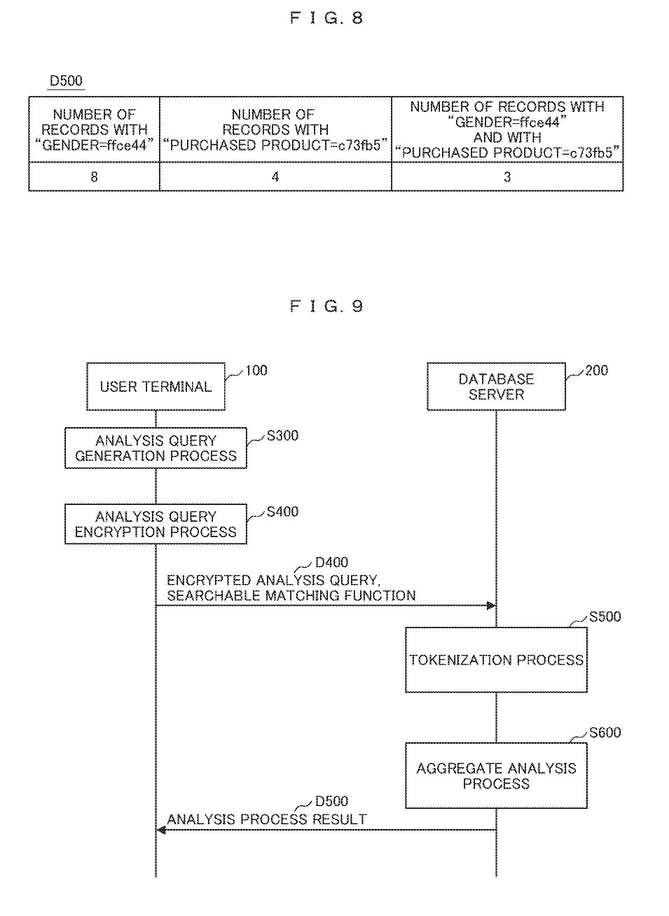

FIG. 8 is an example of the data format of an analysis process result (D500) obtained when the database server 200 performs the aggregate analysis on the encrypted data (D200) by means of the encrypted analysis query (D400). As shown in the figure, the analysis process result shows that the number of records hit in the retrieval on “ffce44” for the data in the gender column by using the searchable encryption matching function is 8, the number of records hit in the retrieval on “c73fb5” for the data in the purchased product column by using the searchable encryption matching function is 4, and the number of records hit in the retrieval on “ffce44” for the data in the gender column by using the searchable encryption matching function and also hit in the retrieval on “c73fb5” for the data in the purchased product column by using the searchable encryption matching function is 3.

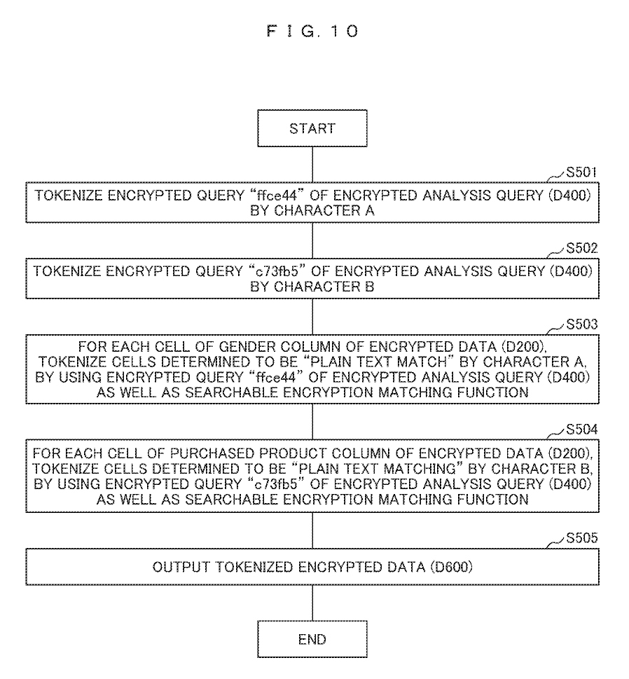

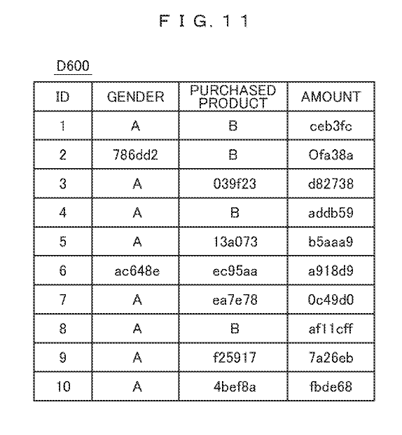

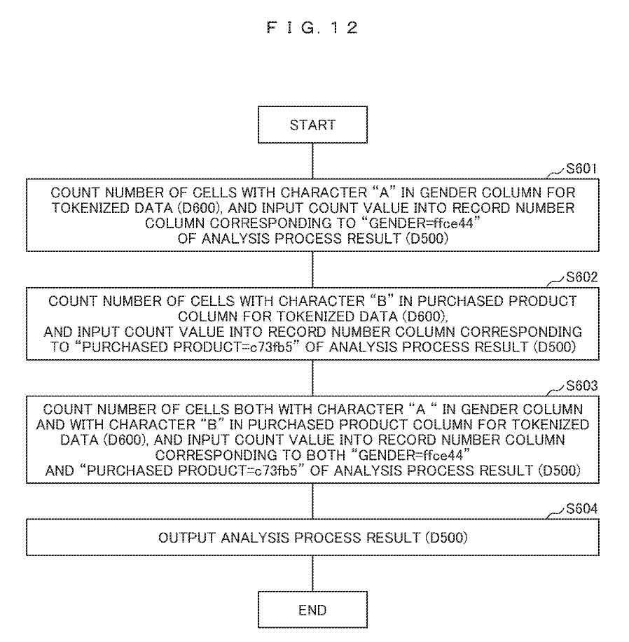

FIG. 9 is a flow chart illustrating an encryption and aggregate analysis process of the user terminal 100 and the database server 200. When requesting aggregate analysis of the following three values: the number of recodes with the value “male” in the gender column, the number of records with “product 1” in the purchased product column, and the number of records both with the value “male” in the gender column and with “product 1” in the purchased product column in the encrypted data (D200), which is stored in the database server 200 by the pre-preservation process described above, the user terminal 100 performs an analysis query generation process to generate the analysis query (D300) shown in FIG. 6 (S300). By treating “male” of the first column, “product 1” of the second column, and “male” and “product 1” of the third, which are the item names in the plain text part of the analysis query (D300) generated by the analysis query generation process (S300), respectively, as plain text, the user terminal 100 generates the encrypted analysis query (D400) by encrypting the plain text with the searchable encrypted query function by using the private key generated in the searchable encrypted private key generation (S100) shown in FIG. 5 (S400). The user terminal 100 transmits the encrypted analysis query (D400) generated by the analysis query encryption process (S400) as well as the searchable encryption matching function to the database server 200.

The database server 200 performs a tokenization process on the received encrypted analysis query (D400) as well as the stored encrypted data (D200), and outputs tokenized encrypted data (D600) (S500). The tokenization process and the tokened encrypted data (D600) will be described later. Next, the database server 200 performs an aggregate analysis on the tokenized encrypted data (D600) to generate the analysis process result (D500) shown in FIG. 8, and transmits the analysis process result (D500) to the user terminal 100 (S600). Here, the process of encryption and aggregate analysis ends.

FIG. 10 is a flow chart illustrating the tokenization process (S500) shown in FIG. 9. The database server 200 tokenizes the encrypted query “ffce44” of the received encrypted analysis query (D400) by the character A (S501). Further, the database server 200 tokenizes the encrypted query “c73fb5” of the encrypted analysis query (D400) by the character B (S502). Then, the database server 200 performs match determination of the plain text by using the encrypted query “ffce44” of the encrypted analysis query (D400) as well as the searchable encryption matching function, for each cell of the gender column of the encrypted data (D200), and tokenizes the cell determined to be “plain text match” by the character A (S503). Similarly, the database terminal 200 performs match determination of the plain text by using the encrypted query “c73fb5” of the encrypted analysis query (D400) as well as the searchable encryption matching function, for each cell of the purchased product column of the encrypted data (D200), and tokenizes the cell determined to be “plain text match” by the character B (S504). The database server 200 outputs the tokenized encrypted data (D600) (S505), and then the process ends.

FIG. 11 shows the tokenized data (D600) obtained by tokenizing the encrypted data (D200). As shown in the figure, in the plain text data (D100), each cell with the plain text “male” in the gender column is tokenized into the character “A” in the tokenization process (S500). Similarly, in the plain text data (D100), each cell with the plain text “product 1” in the purchased product column is tokenized into the character “B” in the tokenization process (S500).

FIG. 12 is a flow chart illustrating the aggregate analysis process (S600) shown in FIG. 9. The database server 200 counts the number of cells with the character “A” in the gender column, with respect to the tokenized data (D600) generated by the tokenization process (S500), and inputs the count value to the record number column corresponding to “gender=ffce44” of the analysis process result (D500) (S601). Also, the database server 200 counts the number of cells with the character “B” in the purchased produce column, and inputs the count value to the record number column corresponding to “purchased product=c73fb5” of the analysis process result (D500) (S602). Similarly, the database server 200 counts the number of records both with the character “A” in the gender column and with the character “B” in the purchased product column, and inputs the count value to the record number column corresponding to both “gender=ffce44” and “purchased product=c73fb5” of the analysis process result (D500) (S603). Then, the database server 200 outputs the analysis process result (D500) (S604), and then the process ends.

According to this example, it is possible to reduce the number of executions of the matching process of the searchable encryption by tokenization. In this way, fast analysis can be achieved while protecting the privacy of the informant by encryption. As a result, the process efficiency of analysis is improved.

### Second Example

In the first example, when the database server 200 performs tokenization on the encrypted data, the appearance frequency of plain text may be known by the database server 200. For example, in the tokenized data (D600) of FIG. 11, the cell with the value “male” in the gender column is tokenized by the character “A”. In this case, if the database server 200 has background knowledge that there are only two values, “male” and “female”, for the gender, and that the appearance frequency of “male” is higher than the appearance frequency of “female” in the plain data, it is presumable that the plain text corresponding to the character “A” is “male”. In this example, in order to deal with the possibility that the appearance frequency is known through tokenization, the appearance frequency information of “male” and “female” is kept secret by using dummy records, flags, and additively homomorphic encryption, in addition to the method described above.

Hereinafter, this example shows an example in which the user terminal 100 requests an aggregation analysis of three values, the number of records with “male” in the gender column, the number of records with “product 1” in the purchased product column, and the number of records both with “male” in the gender column and with “product 1” in the purchased product column with respect to the encrypted data stored in the database 200, similarly to the first example. Unless otherwise stated, it is assumed that the same system configuration, data format, and process flowchart as the example are used.

The additively homomorphic encryption algorithm used in this example is defined. The additively homomorphic encryption algorithm (hereinafter referred to as the additively homomorphic encryption) is a method in which the additive function of the additively homomorphic encryption algorithm has the property of additivity among encrypted texts, in addition to an asymmetric property for encryption and decryption in the normal public key encryption algorithm, which is, for example, described in P. Paillier, Public-Key Cryptosystems Based on Composite Degree Residuosity Classes (Proc. of EURO-CRYTP '99, LNCS 1592, pp. 223-238, 1999). In other words, the method can calculate an encrypted text Enc(a+b), which is the sum of two encrypted texts Enc(a) and Enc(b), a+b, by using only public information.

This example is different from the first example in the data format of the plan text (D100) shown in FIG. 3 as well as the process content of the aggregate analysis process shown in FIG. 12.

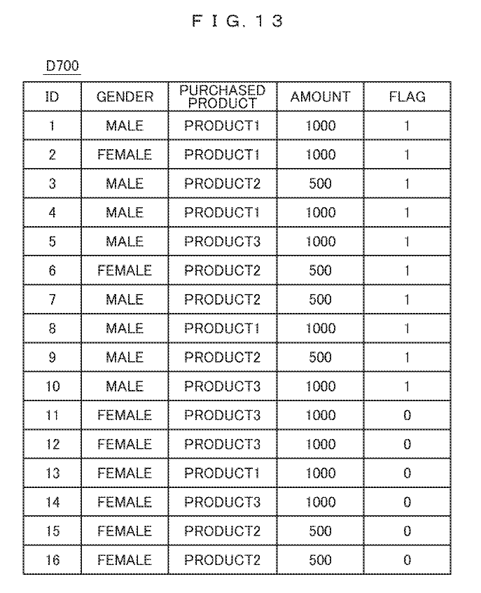

FIG. 13 is an example of the data format of a plain text data (D700) with dummy records held by the user terminal 100 in this example. The difference from FIG. 3 is that dummy record IDs 11 to 16 are added to the plain text data IDs 1 to 10 shown in FIG. 3 so that the appearance frequency of the value “male” is equal to the appearance frequency of the value “female” in the gender column. Since the value of the dummy records in the gender column is “female”, there are 8 records with the value “male” and 8 records with the value “female” in the whole gender column. Thus, there is no difference in the appearance frequency between the values “male” and “female”. Further, in order to prevent the dummy record from affecting the result of aggregation in the aggregate analysis, the flag of the dummy record is set to 0 and the flag of the non-dummy record is set to 1.

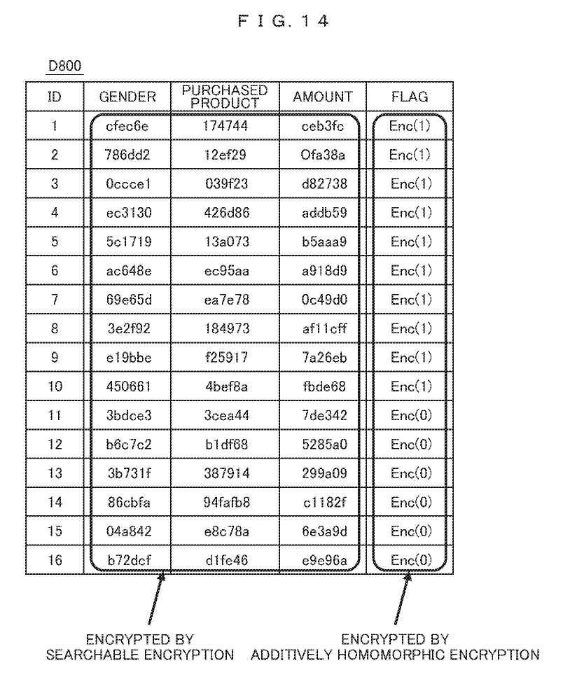

FIG. 14 is an example of the data format of an encrypted data (D800) with dummy records obtained by encrypting the plain text data (D700) with dummy records shown in FIG. 13. As shown in the figure, each cell of the respective columns of gender, purchased product, and amount in the plain text data (D700) with dummy records is encrypted by the searchable cipher encryption function. Further, each cell of the flag column is encrypted by the additively homomorphic encryption algorithm. Hereinafter, as shown in FIG. 14, the encrypted text by the searchable encryption is represented by a random string of characters such as “cfec6e”, and the encrypted texts corresponding to the plain texts 0, 1, . . . n are represented respectively by Enc(0), Enc(1), . . . Enc(n).

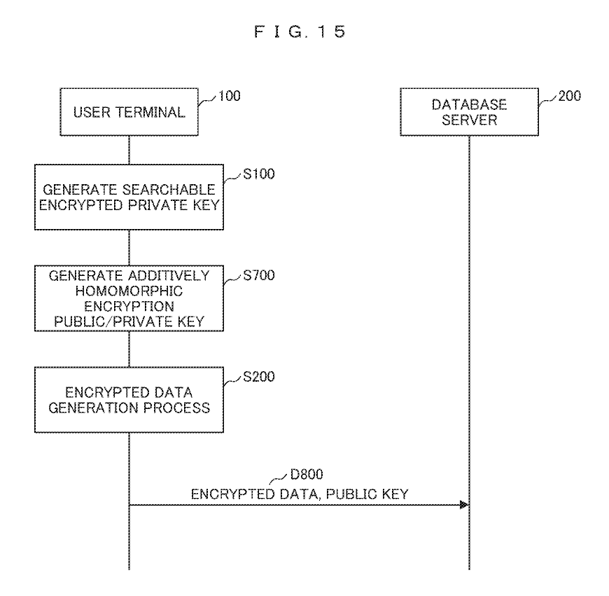

FIG. 15 is a flow chart illustrating the encrypted data pre-preservation process of the user terminal 100 and the database server 200 in this example. The difference between FIG. 15 and FIG. 5 is that a process of generating a public key and private key for additively homomorphic encryption (S700) is added to the process of the user terminal 100. In addition, the user terminal 100 generates the encrypted data with dummy records (D800) of FIG. 14 (S200), and transmits the encrypted data with dummy records (D800) as well as the public key generated by the public key/private key generation process (S700), to the database server 200.

Note that sorting of item names described in each cell of the tabular data when the order of the item names is different depending on the record (row), is done in the same way as in the first example.

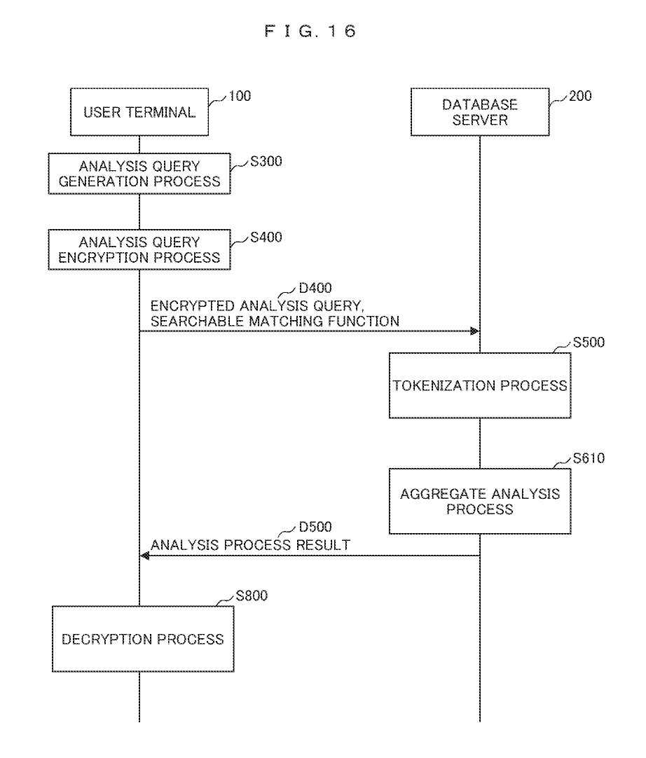

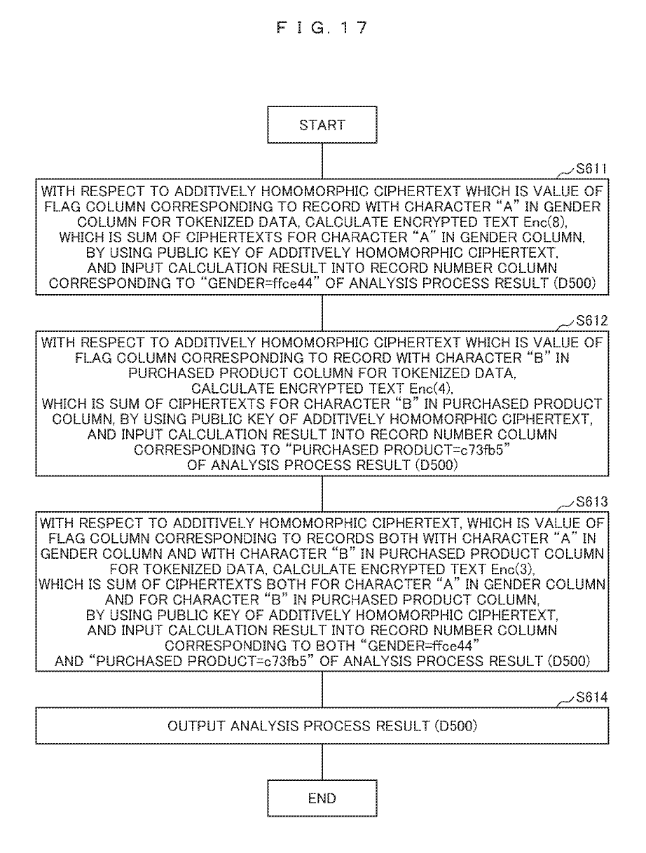

FIG. 16 is a flow chart illustrating the encryption and aggregate analysis process of the user terminal 100 and the database server 200 in this example. The difference from FIG. 9 of the first example is that the process content of an aggregate analysis process (S610) and a decryption process (S800) of the analysis process result (D500) are added to the encryption and aggregate analysis process, which is described below with reference to FIG. 17.

FIG. 17 is a process flow chart of the aggregate analysis process (S610) of FIG. 16 in this example. With respect to the additively homomorphic ciphertext which is the value of the flag column corresponding to the record with character “A” in the gender column for the data tokenized by the tokenization process (S500 in FIG. 16), the database server 200 calculates an encrypted text Enc(8), which is the sum of the ciphertexts for the character “A” in the gender column, by using the public key of the additively homomorphic ciphertext. Then, the database server 200 inputs the calculation result into the record number column corresponding to “gender=ffce44” of the analysis process result (D500) (S611). Similarly, with respect to the additively homomorphic ciphertext which is the value of the flag column corresponding to the record with the character “B” in the purchased product column, the database server 200 calculates an encrypted text Enc(4), which is the sum of the ciphertexts for the character “B” in the purchased product column, by using the public key of the additively homomorphic ciphertext. Then, the databased server 200 inputs the calculation result into the record number column corresponding to “purchased product=c73fb5” of the analysis process result (D500) (S612). Also, with respect to the additively homomorphic ciphertext which is the value of the flag column corresponding to each record, the database server 200 calculates an encrypted text Enc(3), which is the sum of the ciphertexts for the records both with the character “A” in the gender column and with the character “B” in the purchased product column, by using the public key of the additively homomorphic ciphertext. Then, the database server 200 inputs the calculation result into the record number column corresponding to both “gender=ffce44” and “purchased product=c73fb5” of the analysis process result (D500) (S613). The database server 200 outputs the analysis process result (D500) (S614), and then the process ends.

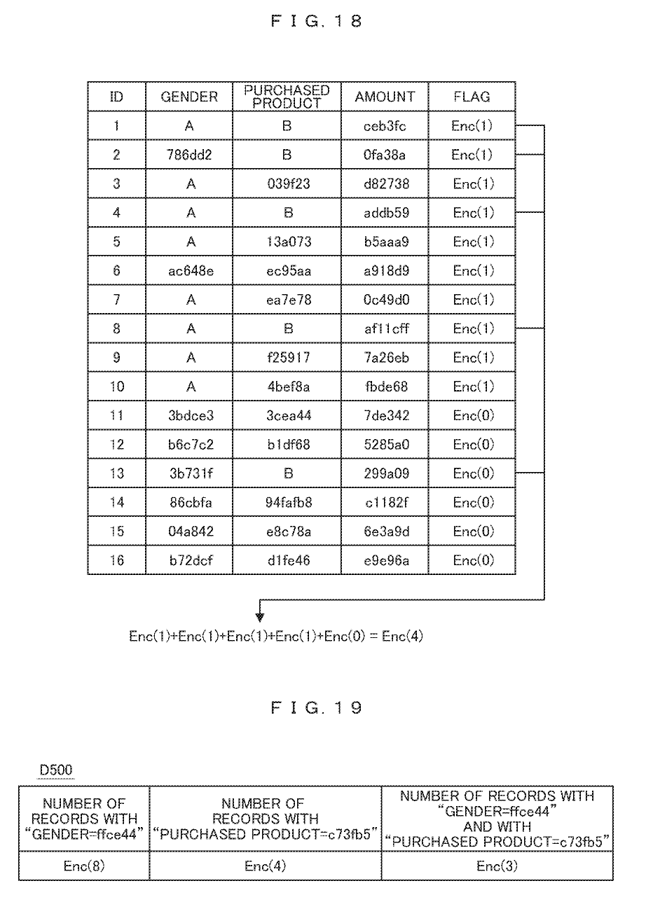

FIG. 18 is a diagram showing the process of calculating the encrypted text Enc(4), which is the sum of ciphertexts for character “B” in the gender column, by using the public key of the additively homomorphic ciphertext, with respect to the additively homomorphic ciphertexts which are the values of the flag column of the records with the character “B” in the purchased product column in the aggregate analysis process (S612) shown in FIG. 17. As shown in the figure, the additively homomorphic ciphertext of the flag column corresponding to each dummy record is Enc(0), so that it does not affect the result of the aggregation.

FIG. 19 is an example of the data format of the analysis process result (D500) in this example. As shown in the figure, unlike the analysis process result (D500) in the first example shown in FIG. 8, the result of the analysis process is output as additively homomorphic ciphertext. The user terminal 100 decodes the additively homomorphic ciphertexts by using the private key generated in the additively homomorphic encryption public/private key generation (S700) of the pre-preservation process shown in FIG. 15 (S800 in FIG. 16), and obtains the process result.

In this example, the user terminal 100 inserts dummy records into the IDs 11 to 16. However, it is not necessarily required to insert dummy records below the rows of records of plain text data. Each dummy record can be inserted into an arbitrary row. Further, the records of the plain text data with dummy records (D700) in which the dummy records are inserted can be replaced with arbitrary ones.

According to this example, by using the dummy records, flags, and additively homomorphic encryption, it is possible to achieve fast analysis while protecting the appearance frequency information relating to the protection of the privacy of the informant by means of encryption, in addition to achieving the reduction in the number of executions of the matching process of searchable encryption.

The present invention is not limited to the embodiment described above, and various changes and modifications may be made within the spirit and scope of the appended claims. For example, the first and second examples show the analysis results on the table having three columns of “gender”, “purchased product”, and “amount” as tabular data. However, the number of columns is not necessarily three and may be an arbitrary number not less than one.

Further, the first and second examples use the common key searchable encryption algorithm as the searchable encryption algorithm, but the searchable encryption of common key system is necessarily used. For example, the searchable cipher encryption function, the searchable encrypted query function, and the searchable encryption matching function that are defined by a specific public key searchable encryption algorithm may be used, respectively, in place of the searchable cipher encryption function, searchable encrypted query function, and searchable encryption matching function of the common key searchable encryption algorithm used in the examples.

Further, the second example uses the public key additively homomorphic algorithm as the additively homomorphic algorithm, but the additively homomorphic encryption of public key system is not necessarily used. For example, the encryption function, decryption function, and additive function defined by a specific common key additively homomorphic encryption algorithm may be used, respectively, in place of the encryption function, decryption function, and additive function of the public key homomorphic encryption algorithm used in the example.

### REFERENCE SIGNS LIST

100: user terminal, 101: CPU, 102: auxiliary storage device (storage device), 103: memory, 104; internal signal line, 105: display device, 106: input/output interface, 107; communication device, 200: database server, 300: network

1.-14. (canceled)

15. A data aggregation/analysis system comprising:
a user terminal including:
a key generation unit that generates a private key or a pair of an encryption key and a decryption key by using a predetermined common key or by using a key generation function of public key searchable encryption algorithm;
an encrypted tabular data generation unit that generates encrypted tabular data by encrypting cells of tabular data by means of an encryption function of the searchable encryption algorithm;
an encrypted analysis query generation unit that generates an encrypted analysis query by encrypting an item name, which is an analysis target of the tabular data, by using the private key or the encryption key based on a searchable encrypted query function of the searchable encryption algorithm;
a first transmission unit that transmits the encrypted tabular data, a searchable encryption matching function of the searchable encryption algorithm, and the encrypted analysis query; and
a database server including:
a storage unit that stores the encrypted tabular data and the searchable encryption matching function, which are received from the user terminal;
a tokenization unit that performs a retrieval process in response to receiving the encrypted analysis query from the user terminal, by using the searchable encryption matching function with the encrypted analysis query and the encrypted tabular data as input, and tokenizes cells hit in the retrieval process on the encrypted tabular data into arbitrary character strings to generate partially-tokenized encrypted tabular data;
a data analysis processing unit that performs a predetermined data analysis process with the partially-tokenized encrypted tabular data as input, to generate a data analysis result; and
a second transmission unit that transmits the data analysis result to the user terminal.

16. The data aggregation/analysis system according to claim 15,
wherein the encrypted analysis query generation unit of the user terminal encrypts the item names, which are the analysis targets, by using the searchable encrypted query function, and generates the encrypted analysis queries corresponding to the respective item names,
wherein the first transmission unit transmits the generated encrypted analysis queries to the database server, and
wherein the tokenization unit of the databased server performs a retrieval process in response to receiving the encrypted analysis queries, by using the searchable encryption matching function with the encrypted analysis queries and the encrypted tabular data as input, and tokenizes cells hit in the retrieval process on the encrypted tabular data with respect to each of the encrypted analysis queries, into arbitrary character strings corresponding to each of the encrypted analysis queries to generate the partially-tokenized encrypted tabular data.

17. The data aggregation/analysis system according to claim 16,
wherein the user terminal further includes a sorting unit that provides a specific total-order structure to the item name described in each cell of the tabular data to sort the item name described in each cell of each row of the tabular data by the total-order structure,
wherein the encrypted analysis query generation unit of the user terminal encrypts the item names, which are the analysis targets of the tabular data, by using the searchable encrypted query function according to the order sorted by the sorting unit, to generate the encrypted analysis queries corresponding to the respective item names, and
wherein the first transmission unit of the user terminal transmits the encrypted analysis queries to the database server according to the order sorted by the sorting unit.

18. A data aggregation/analysis system comprising:
a user terminal including:
a key generation unit that generates a private key or a pair of an encryption key and a decryption key by using a predetermined common key or by using a key generation function of public key searchable encryption algorithm, and generates a private key or a pair of an encryption key and a decryption key by using a predetermined common key or by using a key generation function of public key additively homomorphic encryption algorithm;
an encrypted tabular data generation unit that generates encrypted tabular data from tabular data into which a dummy row and a flag column are inserted, with 0 as the value of a cell in the flag column when the row of the tabular data with dummy is the dummy row and 1 as the value of a cell in the flag column when the row is not the dummy row, by encrypting the cells except the cells in the flag column of the tabular data with dummy by using an encryption function of the searchable encryption algorithm to generate a ciphertext of a searchable encryption, and by encrypting cells in the flag column of the tabular data with dummy by using an encryption function of an additively homomorphic encryption to generate a ciphertext of the additively homomorphic encryption;
an encrypted analysis query generation unit that generates an encrypted analysis query by encrypting an item name, which is an analysis target of the tabular data, by the searchable encrypted query function of the searchable encryption algorithm by using a private key of the searchable encryption algorithm or by using an encryption key;
a decryption unit that performs a decryption process with a received data analysis result and a private key of the additively homomorphic encryption algorithm or a decryption key as input;
a first transmission unit that transmits the encrypted tabular data, a searchable encryption matching function of the searchable encryption algorithm, an encryption key of the additively homomorphic encryption algorithm, and the encrypted analysis query; and
a database server including:
a storage unit that stores the encrypted tabular data, the searchable matching function, and an encryption key of the additively homomorphic encryption algorithm that are received from the user terminal;
a tokenization unit that performs a retrieval process in response to receiving the encrypted analysis query from the user terminal, by using the searchable encryption matching function with the encrypted analysis query and the encrypted tabular data as input, and tokenizes cells hit in the retrieval process on the encrypted tabular data into arbitrary character strings to generate partially-tokenized encrypted tabular data;
a data analysis processing unit that performs a predetermined data analysis process with the partially-tokenized data as input by using an encryption key of the additively homomorphic encryption algorithm, to generate a data analysis result; and
a second transmission unit that transmits the data analysis result to the user terminal.

19. The data aggregation/analysis system according to claim 18,
wherein the first transmission unit of the user terminal transmits an additive function of the additively homomorphic encryption algorithm before the database server performs the data analysis process,
wherein the storage unit of the database server stores the additive function of the additively homomorphic encryption algorithm received from the user terminal, and
wherein when counting the sum of the tokenized cells of each item of the partially-tokenized encrypted tabular data, the data analysis processing unit obtains ciphertext obtained by performing an addition operation by using the additive function, with the ciphertext of the additively homomorphic encryption in the flag column as input, to use the ciphertext as the count value.

20. The data aggregation/analysis system according to claim 19,
wherein the encrypted analysis query generation unit of the user terminal encrypts the item names, which are the analysis targets, by using the searchable encrypted query function, to generate the encrypted analysis queries corresponding to the respective item names, and
wherein the tokenization unit of the database server performs a retrieval process in response to receiving the encrypted analysis queries, by using the searchable encryption matching function with the encrypted analysis queries and the encrypted tabular data as input, and tokenizes cells hit in the retrieval process on the encrypted tabular data into arbitrary character strings corresponding to each of the encrypted analysis queries to generate partially-tokenized encrypted tabular data.

21. The data aggregation/analysis system according to claim 20,
wherein the user terminal further includes a sorting unit that provides a specific total-order structure to the item name described in each cell of the tabular data to sort the item name described in each cell of each row of the tabular data by the total-order structure,
wherein the encrypted analysis query generation unit of the user terminal encrypts the items names, which are the analysis targets of the tabular data, by using the searchable encrypted query function according to the order sorted by the sorting unit, to generate the encrypted analysis queries corresponding to the respective item names, and
wherein the first transmission unit of the user terminal transmits the encrypted analysis queries to the database server, according to the order sorted by the sorting unit.

22. A data aggregation/analysis method in a data aggregation/analysis system configured by connecting a user terminal and a database server,
wherein the user terminal generates a private key or a pair of an encryption key and a decryption key, by using a predetermined common key or by using a key generation function of public key searchable encryption algorithm,
wherein the user terminal encrypts cells of tabular data by using an encryption function of the searchable encryption algorithm to generate encrypted tabular data,
wherein the user terminal transmits the generated encrypted tabular data to the database server,
wherein the user terminal transmits a searchable encryption matching function of the searchable encryption algorithm to the database server,
wherein the database server stores the encrypted tabular data and the searchable encryption matching function that are received from the user terminal,
wherein the user terminal generates an encrypted analysis query by encrypting an item name, which is an analysis target of the tabular data, by using the private key or the encryption key based on a searchable encrypted query function of the searchable encryption algorithm, and transmits the generated encrypted analysis query to the database server,
wherein the database server performs a retrieval process, in response to receiving the encrypted analysis query, by using the searchable encryption matching function with the encrypted analysis query and the encrypted tabular data as input, and tokenizes cells hit in the retrieval process on the encrypted tabular data into arbitrary character strings to generate partially-tokenized encrypted tabular data,
wherein the databased server performs a predetermined data analysis process with the partially-tokenized encrypted tabular data as input, to generate a data analysis result, and
wherein the database server transmits the data analysis result to the user terminal.

23. The data aggregation/analysis method according to claim 22,
wherein the user terminal encrypts the item names, which are the analysis targets, by using the searchable encrypted query function, to generate the encrypted analysis queries corresponding to the respective item names,
wherein the user terminal transmits the generated encrypted analysis queries to the database server,
wherein the database server performs a retrieval process, in response to receiving the encrypted analysis queries, by using the searchable encryption matching function with the encrypted analysis queries and the encrypted tabular data as input, and
wherein the database server tokenizes cells hit in the retrieval process on the encrypted tabular data with respect to each of the encrypted analysis queries, into arbitrary character strings corresponding to each of the encrypted analysis queries to generate partially-tokenized encrypted tabular data.

24. The data aggregation/analysis method according to claim 23,
wherein the user terminal provides a specific total-order structure to the item name described in each cell of the tabular data, and sorts the item name described in each cell of each row of the tabular data by the total-order structure,
wherein the user terminal encrypts the item names, which are the analysis targets of the tabular data, by using the searchable encrypted query function according to the sorted order to generate the encrypted analysis queries corresponding to the respective item names, and transmits the encrypted analysis queries to the database server according to the sorted order.

25. The data aggregation/analysis method according to claim 22,
wherein the tabular data has a dummy row and a flag column,
wherein the user terminal generates tabular data with dummy in which the value of a cell in the flag column is 0 when the row of the tabular data is the dummy row and in which the value of a cell in the flag column is 1 when the row of the tabular data is not the dummy row,
wherein the user terminal generates a private key or a pair of an encryption key and a decryption key, by using a predetermined common key or by using a key generation function of public key additively homomorphic encryption algorithm,
wherein the user terminal generates the encrypted tabular data by encrypting the cells except the cells of the flag column of the tabular data with dummy by using an encryption function of the searchable encryption algorithm, as a ciphertext of a searchable encryption, and by encrypting the cells in the flag column of the tabular data with dummy by using an encryption function of an additively homomorphic encryption, as a ciphertext of the additively homomorphic encryption,
wherein the user terminal transmits the searchable encryption matching function of the searchable encryption algorithm, as well as the encryption key of the additively homomorphic encryption algorithm to the database server,
wherein the database server stores the encrypted tabular data, the searchable encryption matching function, and the encryption key of the additively homomorphic encryption algorithm, which are received from the user terminal,
wherein the database server generates the data analysis result by performing a predetermined data analysis process by using the encryption key of the additively homomorphic encryption algorithm with the partially-tokenized encrypted tabular data as input, and
wherein the user terminal performs a decryption process with the data analysis result and the decryption key as input.

26. The data aggregation/analysis method according to claim 25,
wherein the user terminal transmits the additive function of the additively homomorphic encryption algorithm before the database server additionally performs the data analysis process,
wherein the database server stores the additive function of the additively homomorphic encryption algorithm received from the user terminal, and
wherein when counting the sum of the tokenized cells of each item of the partially-tokenized encrypted tabular data, the data analysis processing unit obtains ciphertext by performing an addition operation by using the additive function of the additively homomorphic encryption, with the ciphertext of the additively homomorphic encryption in the flag column as input, to use the ciphertext as the count value.

27. The data aggregation/analysis method according to claim 26,
wherein the user terminal encrypts the item names, which are the analysis targets, by using the searchable encrypted query function to generate the encrypted analysis queries corresponding to the respective item names,
wherein the user terminal transmits the generated encrypted analysis queries to the database server,
wherein the database server performs a retrieval process in response to receiving the encrypted analysis queries, by using the searchable encryption matching function with the encrypted analysis queries and the encrypted tabular data as input, and
wherein the database server generates the partially-tokenized encrypted tabular data by tokenizing cells hit in the retrieval process on the encrypted tabular data with respect to each of the encrypted analysis queries, into arbitrary character strings corresponding to each of the encrypted analysis queries.

28. The data aggregation/analysis method according to claim 27,
wherein the user terminal comprises:
providing a specific total-order structure to the item names described in the respective cells of the tabular data, and sorts the item names described in the respective cells of each row of the tabular data by the total-order structure;
encrypting the item names by using the searchable encrypted query functions according to the order sorted by the total-order structure, to generate the encrypted analysis queries corresponding to the respective item names; and
transmitting the encrypted analysis queries to the database server according to the order sorted by the total-order structure.
